(19) United States
(12) Patent Application Publication
(10) Pub. No.: US 2015/0308319 A1
(43) Pub. Date: Oct. 29, 2015

(54) Exhaust Gas System with Thermoelectric Generator

(71) Applicant: Bayerische Motoren Werke Aktiengesellschaft, Muenchen (DE)

(72) Inventors: Andreas BAUKNECHT, Muenchen (DE); Samuel BUCHER, Bern (CH)

(21) Appl. No.: 14/699,240

(22) Filed: Apr. 29, 2015

Related U.S. Application Data
(63) Continuation of application No. PCT/EP2013/071272, filed on Oct. 11, 2013.

(30) Foreign Application Priority Data
Oct. 31, 2012 (DE) 10 2012 219 968.3

(51) Int. Cl. F01N 5/02; F02B 37/18

(52) U.S. Cl. CPC F01N 5/025; F02B 37/18

(57) ABSTRACT

An exhaust gas system, in particular for an internal combustion engine, includes an exhaust gas line. The exhaust gas line has at least one turbocharger and a thermoelectric converter arrangement which is arranged downstream of the turbocharger in the flow direction of an exhaust gas and which includes a thermoelectric converter stage. The exhaust gas line is paired with at least one bypass line, which branches out from the exhaust gas line upstream of the turbocharger in an exhaust gas-conductive manner in order to discharge at least one part of the exhaust gas into the at least one bypass line. The at least one bypass line opens into the exhaust gas line downstream of the thermoelectric converter stage in an exhaust gas-conductive manner.

### CROSS REFERENCE TO RELATED APPLICATIONS

This application is a continuation of PCT International Application No. PCT/EP2013/071272, filed Oct. 11, 2013, which claims priority under 35 U.S.C. §119 from German Patent Application No. 10 2012 219 968.3, filed Oct. 31, 2012, the entire disclosures of which are herein expressly incorporated by reference.

### BACKGROUND AND SUMMARY OF THE INVENTION

The invention relates to an exhaust system, in particular for an internal combustion engine, having an exhaust line, wherein the exhaust line includes at least one exhaust-gas turbocharger and, arranged downstream as viewed in a flow direction of an exhaust gas, a thermoelectric converter arrangement with a thermoelectric converter stage.

The exhaust gas of internal combustion engines, for example of motor vehicles, normally exhibits high thermal energy. To make it possible to utilize this thermal energy and prevent an undesired discharge to the environment, exhaust systems are known which include a thermoelectric converter arrangement for the recovery of exhaust gas energy. Such arrangements make it possible, through partial energy recovery, to considerably improve an overall level of energy efficiency of the internal combustion engine.

Here, use is made of thermoelectric generators which, as is known, can be integrated into exhaust-gas catalytic converters and include thermoelectric converter elements which, based on the generally known Seebeck effect, convert thermal energy into electrical energy. In simple terms, for this purpose, a temperature difference between two ends of the converter elements is utilized, such as generally exists, in the case of a motor vehicle, between the exhaust gas and a coolant, which flow separately from one another through the thermoelectric generator. Owing to the fact that a thermoelectric generator is generally known, a detailed description of the physical processes will not be given here.

In the case of the known arrangements, in certain operating ranges—in particular at high loads—of the internal combustion engine, three mutually independent “overload scenarios” can arise. A first overload scenario is encountered in the case of an excessively high exhaust-gas mass flow rate. This leads to an increase in exhaust-gas back pressure and to a considerable increase in charge exchange work of the internal combustion engine, wherein the latter has an adverse effect on full-load fuel consumption and/or full-load power. A further overload scenario may be encountered in the event of an increased heat input into the coolant conducted through the thermoelectric generator, if said heat input cannot be dissipated to an adequate extent by means of the cooling circuit, operatively coupled thereto, of the vehicle. The third overload scenario is encountered in the event of a permitted maximum temperature of the thermoelectric material of the thermoelectric generator being exceeded, which can result in the thermoelectric material becoming damaged. To avoid these overload scenarios, it is known to provide a thermoelectric generator which includes a dedicated bypass which is, for example, integrated in the thermoelectric generator. The known arrangement additionally requires dedicated control of a flow through the bypass.

It is therefore an object of the invention to provide an exhaust system which at least partially eliminates the stated disadvantages and which, in particular, avoids the three above-mentioned overload scenarios to the greatest possible extent in as simple and effective a manner as possible.

This and other objects are achieved according to the invention by an exhaust system, in particular for an internal combustion engine, having an exhaust line. The exhaust line includes at least one exhaust-gas turbocharger and, arranged downstream as viewed in a flow direction of an exhaust gas, a thermoelectric converter arrangement with a thermoelectric converter stage, wherein the exhaust line is assigned at least one bypass line which branches off in exhaust gas-conducting fashion from the exhaust line upstream of the exhaust-gas turbocharger for the purpose of discharging at least a fraction of the exhaust gas into the at least one bypass line. Furthermore, the at least one bypass line opening in exhaust gas-conducting fashion into the exhaust line downstream of the thermoelectric converter stage.

Thus, one or more bypass lines are proposed which branch(es) off from the exhaust line upstream of an exhaust-gas turbocharger or the turbine thereof for the purpose of discharging at least a part of the exhaust gas out of the exhaust line into the respective bypass line, and returning said exhaust gas into the exhaust line downstream of the thermoelectric converter stage.

The at least partial discharge of the exhaust gas upstream of the exhaust-gas turbocharger or of the turbine thereof thus serves firstly for charge pressure reduction for the turbine of the exhaust-gas turbocharger.

Secondly, by way of the arrangement, it is achieved that the exhaust-gas stream which impinges on the thermoelectric converter stage can also be influenced by the at least partial discharge of the exhaust gas. In this way, it is advantageously possible for the three above-mentioned overload scenarios to be avoided, or for the effect thereof to be reduced, in particular at high engine loads with high exhaust-gas mass flow rates and particularly high exhaust-gas temperatures.

The arrangement consequently makes it possible to realize a combined bypass arrangement for the exhaust-gas turbocharger or the turbine thereof and, simultaneously, for the thermoelectric converter stage. The arrangement is a particularly simple configuration and has a small structural space requirement. In other words, it is instead achieved that the exhaust-gas turbocharger and the converter stage together share the same bypass line and thus, in an advantageous manner, it is possible to dispense with an additional separate bypass arrangement for the thermoelectric generator and with separate control of a flow through the bypass arrangement.

In a further embodiment, the thermoelectric converter arrangement includes a catalytic converter stage which is arranged downstream of the thermoelectric converter stage as viewed in the flow direction of the exhaust gas. The at least one bypass line opens in exhaust gas-conducting fashion into the exhaust line between the thermoelectric converter stage and the downstream catalytic converter stage.

By way of this embodiment, it is thus the case that the exhaust gas that is conducted through the at least one bypass line is returned into the exhaust line again upstream of the catalytic converter stage. It is thus possible by means of the one or more bypass lines for the thermoelectric converter stage to be bypassed, but at the same time, the catalytic converter stage can be utilized both for the exhaust gas flowing in the exhaust line and also for the exhaust gas that is conducted through the bypass line(s). It is consequently possible to dispense with an additional catalytic converter arrangement within the bypass lines.

The thermoelectric converter stage may, for example, include a thermoelectric generator.

Furthermore, the thermoelectric generator may be arranged within the exhaust line in order for the thermoelectric generator to be impinged on by the exhaust gas that is conducted in the exhaust line. This means that the thermoelectric generator is located directly in the exhaust line and is thus impinged or acted on directly by the exhaust-gas stream conducted therein.

In a further embodiment, the thermoelectric converter stage includes at least one heat exchanger and a cooling circuit that is coupled to the heat exchanger.

Accordingly, the thermoelectric converter stage is configured such that one or more heat exchangers are operatively coupled to the exhaust line in order to effect an exchange of heat between the exhaust line and the cooling circuit that is coupled to the heat exchanger. For this purpose, the heat exchanger may be indirectly or directly coupled in heat-exchanging fashion to the exhaust gas that is conducted in the exhaust line.

Furthermore, the thermoelectric generator of the thermoelectric converter stage may be operatively coupled to the cooling circuit. In this case, the thermoelectric generator is arranged within the cooling circuit and thus outside the exhaust line. Preferably, an exchange of heat to a cooling medium of the cooling circuit takes place by way of the heat exchanger that is operatively coupled to the exhaust line, and the cooling medium is heated. The heated cooling medium in turn impinges downstream on the thermoelectric generator and thus provides, through a supply of heat, the temperature difference required for energy recovery.

The thermoelectric generator may, for example, have a thermoelectric sandwich-like structure and/or a thermoelectric tube structure, in particular a tube bundle heat exchanger.

Furthermore, the at least one bypass line may include a control element, in particular an actuable flap, for the selective and at least partial closure and/or opening of the bypass line. The control element is preferably in the form of a wastegate flap of an exhaust-gas turbocharger. These are already designed for the prevailing exhaust-gas temperatures in the region of the exhaust-gas catalytic converter. It is self-evident here that specific adaptations, for example with regard to geometrical aspects, are possible if necessary. The use of a wastegate flap furthermore offers the advantage that this must generally be provided for the exhaust-gas turbocharger in any case, such that owing to the combined bypass line(s) and the control element thereof, this control element can also be utilized for the thermoelectric converter stage. Consequently no additional component is necessary, which has the effect that, for this purpose, there are no additional costs and no additional risk of failure.

Alternatively, use may be made of other control elements which are suitable for withstanding the locally prevailing temperatures and for realizing the intended function.

Regardless of the embodiment of the control element, this may be arranged either in the region of an inlet point of the respective bypass line, that is to say in the region of the discharge point from the exhaust line, or in the region of the outlet point of the respective bypass line, that is to say in the region in which said bypass line opens into the exhaust line. Positions within the bypass line between the inlet region and the outlet region are self-evidently also possible. Likewise, each bypass line may be assigned a dedicated control element or multiple control elements at the stated positions. It is likewise possible for one control element to be assigned jointly to multiple bypass lines.

In another embodiment, the thermoelectric converter stage includes a radial catalytic converter and/or an axial catalytic converter.

Furthermore, the at least one bypass line may be formed substantially externally with respect to the exhaust line. This means that one or at least one of the multiple bypass lines is substantially separate from the exhaust line, and thus not integrated into the components of the exhaust line. Although coupling sections may be provided, in particular, in the region of the inlet region and of the outlet region for the purpose of connecting a line section of the bypass line or multiple bypass lines, complete integration into the other components should preferably not be provided. This design permits particularly simple and inexpensive production and assembly.

Alternatively, the one or more bypass lines may be realized by geometric adaptation of a wastegate duct of the exhaust-gas turbocharger, such that the duct branches off from and opens into the exhaust line at the described inlet and outlet points.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic block diagram of an exhaust system as per the prior art;

FIG. 2 is a schematic block diagram of an exhaust system having a bypass line and a converter arrangement according to an embodiment of the present invention; and

FIG. 3 is a schematic diagram of an alternative embodiment of a converter arrangement for an exhaust system as per FIG. 2.

### DETAILED DESCRIPTION OF THE DRAWINGS

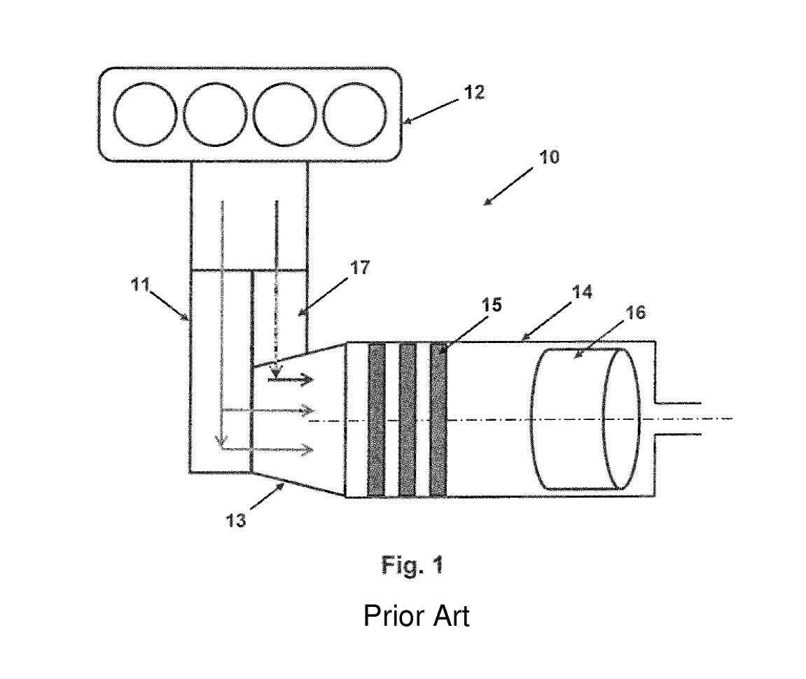

FIG. 1 illustrates an exhaust system 10 according to the prior art. The exhaust system 10 includes an exhaust line 11 with a manifold 12, which can be connected, for example, to an internal combustion engine (not illustrated) of a motor vehicle for the purpose of discharging an exhaust gas. Furthermore, the exhaust line 11 includes an exhaust-gas turbocharger with a turbine 13 and includes a head pipe 14 arranged downstream. The head pipe 14 has an integrated thermoelectric generator 15 and an exhaust-gas catalytic converter 16 arranged downstream of the thermoelectric generator as viewed in the flow direction. The exhaust-gas catalytic converter is, for example, designed as an axial catalytic converter. The exhaust system 10 may furthermore be divided into a hot side (“hot end”) and a cold side (“cold end”), wherein the “hot end” includes the following components: exhaust line 11, manifold 12, turbine 13 and a bypass line 17. The “cold end” includes, in this case, the following components: head pipe 14 and exhaust-gas catalytic converter 16.

The bypass line 17 branches off from the exhaust line 11 upstream of the turbine 13 as viewed in the flow direction, and normally opens into the exhaust line 11, for the purpose of returning the branched-off exhaust gas, downstream of the turbine 13.

The thermoelectric generator 15 is a system for realizing exhaust-gas energy recovery, and utilizes the so-called “Seebeck effect” to convert heat into electrical energy. For this purpose, a temperature difference is necessary, which is generated between the exhaust gas conducted in the exhaust line 11 and a coolant flowing through the thermoelectric generator 15.

The known arrangement 10, however, has the disadvantage that, in certain operating states of the internal combustion engine, an exhaust-gas back pressure that is generated increases, such that charge exchange work of the internal combustion engine disadvantageously increases as a result. Furthermore, an introduction of heat into a coolant of the thermoelectric generator 15 may increase to such an extent that it cannot be discharged to an adequate extent by the coolers that are used. Furthermore, there is the risk of thermoelectric material of the thermoelectric generator being damaged owing to an excessively high exhaust-gas temperature.

In the embodiment illustrated, the thermoelectric generator 15 is designed for example as a so-called radial catalytic converter. This means that flow enters it axially but passes through it in a radial direction. Furthermore, the head pipe 14 includes—as described—the exhaust-gas catalytic converter 16 as a second catalytic converter element, which is illustrated by way of example as being an axial catalytic converter. The division into a first 15 and a second catalytic converter 16, each with a separate monolith, permits, in particular, advantageous warm-up behavior and improved emissions control.

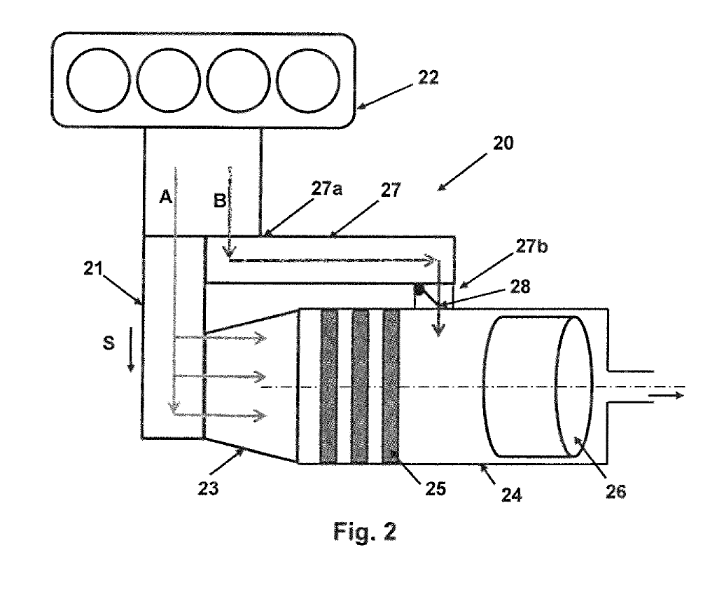

FIG. 2 shows an exhaust system 20—for example for an internal combustion engine—with an exhaust line 21, wherein the exhaust line 21 includes an exhaust-gas turbocharger or the turbine 23 thereof and a thermoelectric converter arrangement 24 arranged downstream as viewed in the flow direction S of an exhaust gas. The thermoelectric converter arrangement has a thermoelectric converter stage 25. The exhaust line 21 is assigned a bypass line 27 which branches off in exhaust gas-conducting fashion from the exhaust line 21 upstream of the turbine 23 of the exhaust-gas turbocharger for the purpose of discharging at least a fraction of the exhaust gas into the bypass line 27. The bypass line 27 opens in exhaust gas-conducting fashion into the exhaust line 21 downstream of the thermoelectric converter stage 25, or into the downstream part of the converter arrangement 24.

The thermoelectric converter arrangement 24 furthermore includes a catalytic converter stage 26 which is arranged downstream of the thermoelectric converter stage 25 as viewed in the flow direction S of the exhaust gas, which catalytic converter stage is, for example, in the form of an axial catalytic converter. The bypass line 27 thus opens in exhaust gas-conducting fashion into the exhaust line 21 or the converter arrangement 24 between the thermoelectric converter stage 25 and the catalytic converter stage 26 situated downstream.

In the embodiment illustrated, the thermoelectric converter stage 25 is in the form of a thermoelectric generator and arranged within the exhaust line 21, such that the exhaust gas flowing in the exhaust line 21 flows through and impinges on the thermoelectric converter stage directly.

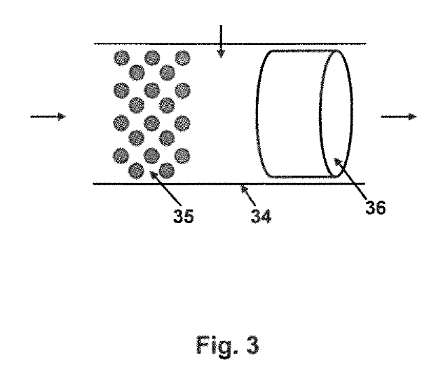

The thermoelectric generator has a thermoelectric sandwich-like structure. An alternative to this is illustrated in FIG. 3.

To influence a flow through the bypass line 27, the bypass line 27 includes a control element 28 (merely schematically indicated), for example in the form of an actuable flap, for the selective and at least partial closure and/or opening of the bypass line 27. When the control element 28 is situated in a closed position, the bypass line 27 is closed, such that a throughflow of exhaust gas is prevented and the exhaust gas is conducted entirely through the exhaust line 21 (arrow A).

By contrast, when the control element 28 is situated in an at least partially open position, at least a fraction of the exhaust gas can flow through the bypass line 27 (arrow B). A remaining fraction of the exhaust gas, if present, continues to follow the exhaust line 21 (arrow A).

The control element 28 may, for example, be in the form of a wastegate flap. Furthermore, the control element 28 may be arranged at any desired point in the bypass line 27, preferably in the region of an inlet point 27a or in the region of the illustrated outlet point 27b.

As can likewise be seen from FIG. 2, the bypass line 27 is formed substantially externally with respect to the exhaust line 21, and is connected to the exhaust line, or to the components of the exhaust line 21, only in the region of the inlet point 27a and the region of the outlet point 27b.

FIG. 3 shows an alternative embodiment of a converter arrangement 34 for an exhaust system 20 as per FIG. 2. The converter arrangement 34 that is illustrated likewise includes a converter stage 35 and a catalytic converter stage 36. By contrast to the converter arrangement 24 from FIG. 2, the converter stage 25 illustrated in FIG. 3 has a thermoelectric tube structure. This may, for example, also constitute a tube bundle heat exchanger.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An exhaust system for an internal combustion engine, the exhaust system comprising:
an exhaust line comprising at least one exhaust-gas turbocharger and, arranged downstream viewed in a flow direction of an exhaust gas, a thermoelectric converter arrangement having a thermoelectric converter stage; and
at least one bypass line configured to branch-off the exhaust line in an exhaust gas-conducting fashion upstream of the exhaust-gas turbocharger, wherein at least a fraction of the exhaust gas is discharged into the bypass line, and
the bypass line opens in an exhaust gas-conducting fashion into the exhaust line downstream of the thermoelectric converter stage.

2. The exhaust system according to claim 1, wherein the thermoelectric converter arrangement comprises:
a catalytic converter stage arranged downstream of the thermoelectric converter stage viewed in the flow direction of the exhaust gas,
wherein the bypass line opens in the exhaust gas-conducting fashion into the exhaust line between the thermoelectric converter stage and the downstream catalytic converter stage.

3. The exhaust gas system according to claim 2, wherein the thermoelectric converter stage comprises a thermoelectric generator.

4. The exhaust gas system according to claim 1, wherein the thermoelectric converter stage comprises a thermoelectric generator.

5. The exhaust gas system according to claim 3, wherein the thermoelectric generator is arranged within the exhaust line so that the exhaust gas conducted in the exhaust line impinges on the thermoelectric generator.

6. The exhaust gas system according to claim 4, wherein the thermoelectric generator is arranged within the exhaust line so that the exhaust gas conducted in the exhaust line impinges on the thermoelectric generator.

7. The exhaust gas system according to claim 1, wherein the thermoelectric converter stage comprises at least one heat exchanger and a cooling circuit operatively coupled to the heat exchanger.

8. The exhaust gas system according to claim 5, wherein the thermoelectric converter stage comprises at least one heat exchanger and a cooling circuit operatively coupled to the heat exchanger.

9. The exhaust gas system according to claim 8, wherein the thermoelectric generator of the thermoelectric converter stage is operatively coupled to the cooling circuit.

10. The exhaust gas system according to claim 4, wherein the thermoelectric generator is configured as a thermoelectric sandwich structure.

11. The exhaust gas system according to claim 3, wherein the thermoelectric generator in configured as a thermoelectric tube structure.

12. The exhaust gas system according to claim 1, further comprising a control element for the bypass line, the control element selectively controlling an opening or closing of the bypass line.

13. The exhaust gas system according to claim 12, wherein the control element is an actuatable flap arranged in the bypass line.

14. The exhaust gas system according to claim 1, wherein the thermoelectric converter stage comprises a radial catalytic converter.

15. The exhaust gas system according to claim 1, wherein the thermoelectric converter stage comprises an axial catalytic converter.

16. The exhaust gas system according to claim 14, wherein the thermoelectric converter stage comprises an axial catalytic converter.

17. The exhaust gas system according to claim 1, wherein the bypass line is formed substantially externally with respect to the exhaust line.

18. The exhaust gas system according to claim 2, wherein the bypass line is formed substantially externally with respect to the exhaust line.
